(19) United States
(12) Patent Application Publication
(10) Pub. No.: US 2019/0070758 A1
(43) Pub. Date: Mar. 7, 2019

(54) ELECTRONIC GLOVE FOR MAKING A THREE DIMENSIONAL STRUCTURE

(71) Applicants: Zheng Shi, Beijing (CN); Hanyin Ye, Beijing (CN); Huihui Wang, Beijing (CN)

(72) Inventors: Zheng Shi, Beijing (CN); Hanyin Ye, Beijing (CN); Huihui Wang, Beijing (CN)

(21) Appl. No.: 16/177,451

(22) Filed: Nov. 1, 2018

Related U.S. Application Data
(63) Continuation-in-part of application No. PCT/CN2017/083661, filed on May 9, 2017.

(30) Foreign Application Priority Data
May 10, 2016 (CN) 2016103042185

(51) Int. Cl. B29C 43/02; B29C 43/52; B29C 43/58

(52) U.S. Cl. CPC B29C 43/02; B29K 2101/12; B29C 43/58; B29C 43/52

(57) ABSTRACT

The present invention provides an electronic glove device for making three-dimensional structure. The device includes a heating unit, multiple pressure sensors and a microcomputer unit. The heating unit includes a first thermally conductive layer and a thermally insulated layer, and multiple electric heaters and temperature sensors are located between the first thermally conductive layer and the thermally insulated layer. The microcomputer unit is connected to the temperature sensors and the pressure sensors. Once pressure is exerted on thermoplastic plastic through the heating unit by hands, the microcomputer unit is configured to receive the increase of the pressure from the pressure sensors, and to direct the heating unit to increase the temperature of the first thermally conductive layer in accordance with the magnitude of the increase of the pressure. Use of the electronic glove, in combination with thermoplastic plastic, enables users to manually make three-dimensional structures easily and quickly.

### CROSS-REFERENCE TO RELATED APPLICATION

This application is a continuation in part of International Patent Application No. PCT/CN2017/083661, entitled “An Electronic Glove for Making a Three Dimensional Structure”, filed on May 9, 2017, which claims priority of Patent Application CN2016103042185, entitled “An Electronic Glove for Making a Three Dimensional Structure”, filed on May 10, 2016. The entire disclosure of the above application is incorporated herein by reference.

### TECHNICAL FIELD

The present invention provides an electronic glove for making a three-dimensional structure manually.

### BACKGROUND

Rapid prototyping is a group of techniques used to quickly fabricate a scale model of a physical part or assembly using three-dimensional computer aided design (CAD) data. Construction of the part or assembly is usually done using 3D printing or “additive layer manufacturing” technology. However, no effective rapid prototyping methods are currently available to avoid complicated 3D modeling and conversion of models into products, waste of expensive raw materials, laborious manufacturing for a long period of time, and the difficulty of long-time storage after prototyping.

Therefore, it is desired to develop a new device and method that can quickly and easily create three-dimensional structures, such as various models, DIY works and practical structures, and artistic works inspired by creativity as well.

### SUMMARY OF THE INVENTION

Aiming to solve the problems above, the present invention provides an electronic glove for making a three-dimensional structure.

In accordance with one embodiment of the present invention, the electronic glove device includes a heating unit, multiple pressure sensors and a microcomputer unit. The heating unit includes a first thermally conductive layer and a thermally insulated layer, and multiple electric heaters and temperature sensors are located between the first thermally conductive layer and the thermally insulated layer. The microcomputer unit is connected to the temperature sensors and the pressure sensors. Once pressure is exerted on thermoplastic plastic through the heating unit by hands, the microcomputer unit is configured to receive the increase of the pressure from the pressure sensors, and to direct the heating unit to increase the temperature of the first thermally conductive layer in accordance with the magnitude of the increase of the pressure.

In accordance with one embodiment of the present invention, the temperature of the first thermally conductive layer is less than or equal to 240 degrees Celsius.

In accordance with one embodiment of the present invention, the microcomputer unit is configured to control the temperature of each electric heater separately.

In accordance with one embodiment of the present invention, the electronic glove further includes a human-machine interface that is configured to input the default parameters and to indicate the real-time status of the device.

In accordance with one embodiment of the present invention, the electronic glove further includes a cooling unit that is configured to adjust temperatures of a lining layer. The cooling unit includes a second thermally conductive layer, a concentrator, a convective tube, and multiple cooling nets. The second thermally conductive layer is located on the inner side of the thermally insulated layer, and the cooling nets are located between the thermally insulated layer and the second thermally conductive layer.

The present invention provides a method for making a three-dimensional structure with an electronic glove, including the following steps:

exerting pressure on thermoplastic plastic through a heating unit by hands; the heating unit includes a first thermally conductive layer and a thermally insulated layer, and multiple electric heaters and temperature sensors are located between the first thermally conductive layer and the thermally insulated layer;

receiving the increase of the pressure from a plurality of pressure sensors by a microcomputer unit;

directing, by the microcomputer unit, the heating unit to increase the temperature of the first thermally conductive layer in accordance with the magnitude of the increase of the pressure.

With the design disclosed in the present invention, the electronic glove, in combination with thermoplastic plastic, will enable users to manually make three-dimensional structures easily and quickly. In addition, thermoplastic plastic can be used repeatedly, and thus is suitable for long time storage after being taken shape.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are only for exemplary embodiments of the present invention, and that a person of ordinary skill in the art may derive additional drawings without deviating from the principles of the present invention.

FIG. 1 is a sectional view of the axial structure of the electronic glove for making a three-dimensional structure in accordance with one embodiment of the invention.

FIG. 2 is a schematic diagram illustrating the process flow of the electronic glove for making a three-dimensional structure in accordance with another embodiment of the invention.

FIG. 3 is a schematic diagram illustrating the application of the electric glove in making carrot by hands in accordance with another embodiment of the invention.

### DETAILED DESCRIPTION OF THE INVENTION

Reference will now be made in detail to various embodiments of the invention illustrated in the accompanying drawings. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims.

Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

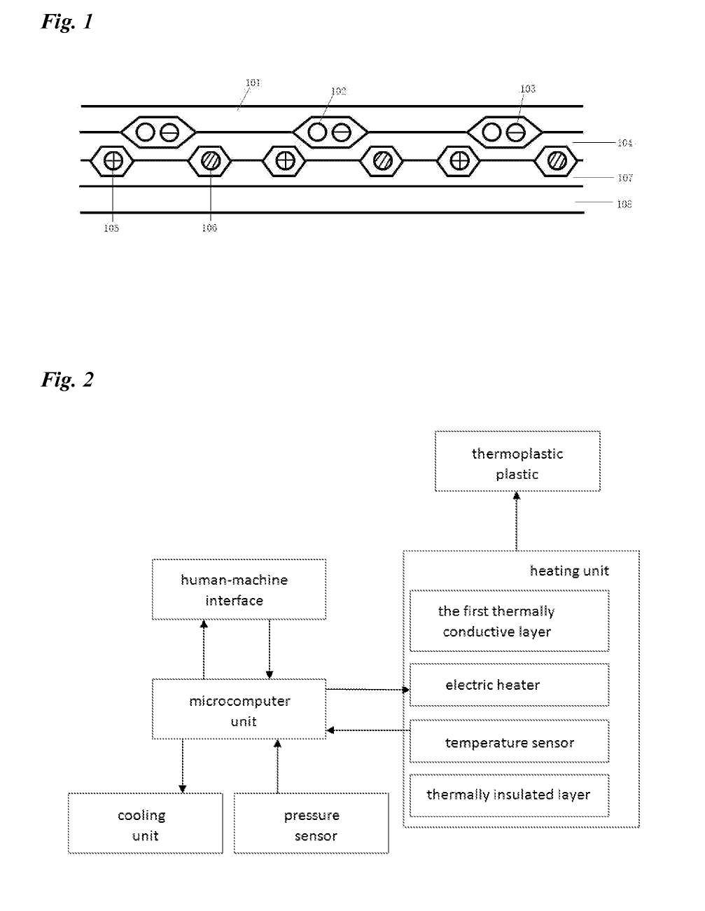

The present invention provides an electronic glove for manually making a three-dimensional structure. The overall temperature of the electronic glove can be preset, and the temperature of a particular part of the electronic glove can be intelligently adjusted, depending on pressing forces exerted on it. The sectional view of the axial structure of the electronic glove is shown in FIG. 1. The electronic glove device includes a heating unit, multiple pressure sensors 105, a microcomputer unit, a cooling unit, and a lining layer 108. The heating unit includes a first thermally conductive layer 101 and a thermally insulated layer 104, and multiple electric heaters 102 and temperature sensors 103 are located between the first thermally conductive layer 101 and the thermally insulated layer 104. The pressure sensors 105 are located between the thermally insulated layer 104 and a second thermally conductive layer 107. The microcomputer unit is connected to the temperature sensors 103 and the pressure sensors 105. The cooling unit includes the second thermally conductive layer 107, a concentrator, a convective tube, and multiple cooling nets 106. The second thermally conductive layer 107 is located on the inner side of the thermally insulated layer 104, and the cooling nets 106 are located between the thermally insulated layer 104 and the second thermally conductive layer 107. Once pressure is exerted on thermoplastic plastic through the heating unit by hands, the microcomputer unit is configured to receive the increase of the pressure from the pressure sensors 105, and to direct the heating unit to increase the temperature of the first thermally conductive layer 101 in accordance with the magnitude of the increase of the pressure.

The electronic glove further includes a human-machine interface and a power unit. The human-machine interface is configured to input the default parameters and to indicate the real-time status of the device. The power unit is configured to supply working power for the microcomputer unit and high power for the heating unit.

The first thermally conductive layer 101 is sufficiently thermally conductive to transfer the heat generated by the electric heaters 102 to the thermoplastic plastic. However, the temperature of the first thermally conductive layer 101 cannot be higher than 240 degrees Celsius. The first thermally conductive layer 101 is waterproof, anti-sticking, and easy to clean. The thermally insulated layer 104 isolates high temperature and prevents heat from transferring to the lining layer 108. The lining layer 108 is in contact with human body and should be easily cleaned and make people feel comfortable.

The microcomputer unit controls the workflow of the system, such as the human-computer interaction, the data collection of the temperature and pressure parameters, and opening and closing of the heating unit. The microcomputer unit controls the temperature of each electric heater 102 separately, in order to achieve complete control of the temperature of the electronic glove. The microcomputer unit further includes a main control board, a number of signal processing circuits, multiple on-off controllers, and signal lines. The main control board is located at the back of the hand (place of the minimum movement) and includes a CPU, resistor/capacitor units, reset circuits, and crystal oscillating circuits. The signal processing circuits refer to all of the back-end assembly units, such as isolator and signal-amplifiers. The on-off controllers control the various electric heaters 102 by switching the power on/off, in order to reach preset temperatures for different parts of the electronic glove. The signal lines connect all units and modules.

The temperature sensors 103 collect surrounding temperature values, and transfer them to the microcomputer unit. The pressure sensors 105 read the pressure values produced by bending and touching the thermoplastic plastic of fingers, and transfer these values to the microcomputer unit. The electric heaters 102, the temperature sensors 103 and the pressure sensors 105 are close to but do not overlap with each other, which make the thickness of the electronic glove as small as possible. And the electric heaters 102, the temperature sensors 103 and the pressure sensors 105 are not evenly distributed all over the electronic glove although they completely cover the electronic glove. Instead, these sensors are relatively concentrated in the fingers and the center of the palm.

The cooling unit is used to adjust the temperature of the lining layer 108, which ensures that users can use the electronic glove for a long period of time. The cooling nets 106 completely cover the electronic glove, and are configured to collect excessive heat penetrated through the thermally insulated layer 104. The concentrator aggregates the cooling nets 106, and is filled with high density convective tubes. The convective tubes facilitate the heat exchange between the excessive heat in the electronic glove and the ambient environment outside the glove. The second thermally conductive layer 107 is designed to increase the coverage of cooling, in combination with the cooling nets 106.

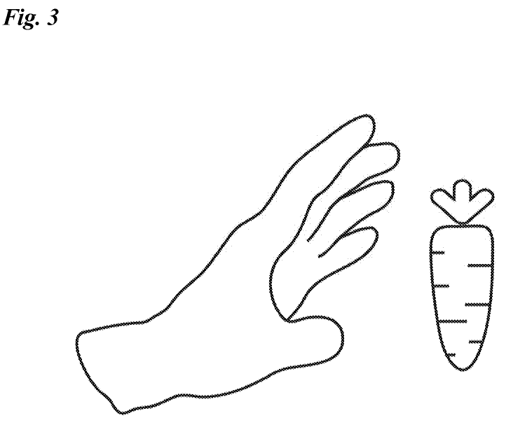

As shown in FIG. 2, the present invention provides a method for making a three-dimensional structure with an electronic glove, in the following steps:

First, the electronic glove starts to work, and the user presets an overall temperature range through the human-machine interface. The temperature of all electric heaters cannot be out of the temperature range until another temperature range is set.

Second, the user exerts pressure on thermoplastic plastic through the heating unit by hands.

Third, the microcomputer unit receives the increase of the pressure from pressure sensors.

Fourth, the microcomputer unit directs the heating unit to increase the temperature of the first thermally conductive layer in accordance with the magnitude of the increase of the pressure.

Fifth, the cooling unit adjusts the temperature of the lining layer.

During the above process of using the electronic glove, the user can examine the current state of the device through the human-machine interface.

The microcomputer unit controls the temperature of each electric heater separately, according to the pressure values. The temperature and the pressure are positively correlated, i.e., the bigger is the pressure, the higher is the temperature. In practice, the stronger is the force for fabricating the three-dimensional structure (the bigger is the pressure), the more quickly the spot taking the force needs to sink. As a result, the temperature of the spot needs to increase quickly to improve the efficiency.

The electric glove can be used to manually make carrot, as shown in FIG. 3. The thermoplastic plastic used in this embodiment doesn't release harmful smoke after being heated. Once the electronic glove device is started, the user presets an overall temperature range through the human-machine interface. The temperature of all electric heaters cannot be out of the temperature range until another temperature range is set. The user exerts pressure on thermoplastic plastic through the heating unit by hands. The microcomputer unit receives the increase of the pressure from pressure sensors, and then directs the heating unit to increase the temperature of the first thermally conductive layer in accordance with the magnitude of the increase of the pressure. The cooling unit adjusts the temperature of the lining layer, which ensures that user can use the electronic glove for a long period of time. During the process of using the electronic glove, the user can examine the current state of the device through the human-machine interface. The user creates a carrot-shaped structure with the thermoplastic plastic, and paint the carrot with different colors, which completes the making of the structure.

1. An electronic glove for making a three dimensional structure, comprising:
a heating unit that comprises a first thermally conductive layer and a thermally insulated layer, wherein a plurality of electric heaters and a plurality of temperature sensors are located between the first thermally conductive layer and the thermally insulated layer;
a plurality of pressure sensors;
a microcomputer unit connected to the temperature sensors and the pressure sensors;
wherein, upon pressure being exerted on thermoplastic plastic through the heating unit by hands, the microcomputer unit is configured to receive the increase of the pressure from the pressure sensors, and to direct the heating unit to increase the temperature of the first thermally conductive layer in accordance with the magnitude of the increase of the pressure.

2. The electronic glove of claim 1, wherein the temperature of the first thermally conductive layer is less than or equal to 240 degrees Celsius.

3. The electronic glove of claim 1, wherein the microcomputer unit is configured to control the temperature of each of the plurality of electric heaters separately.

4. The electronic glove of claim 1, wherein the electronic glove further comprises a human-machine interface, and wherein the human-machine interface is configured to input the default parameters and to indicate the real-time status.

5. The electronic glove of claim 1, wherein the electronic glove further comprises a cooling unit that is configured to adjust temperatures of a lining layer.

6. The electronic glove of claim 5, wherein the cooling unit comprises a second thermally conductive layer, a concentrator, a convective tube and a plurality of cooling nets, and wherein the second thermally conductive layer is located on the inner side of the thermally insulated layer, and wherein the cooling nets are located between the thermally insulated layer and the second thermally conductive layer.

7. A method for making a three-dimensional structure with an electronic glove, comprising:
exerting pressure on thermoplastic plastic through a heating unit by hands, wherein the heating unit comprises a first thermally conductive layer and a thermally insulated layer, and wherein a plurality of electric heaters and a plurality of temperature sensors are located between the first thermally conductive layer and the thermally insulated layer;
receiving the increase of the pressure from a plurality of pressure sensors by a microcomputer unit;
directing, by the microcomputer unit, the heating unit to increase the temperature of the first thermally conductive layer in accordance with the magnitude of the increase of the pressure.

8. The method of claim 7, wherein the temperature of the first thermally conductive layer is less than or equal to 240 degrees Celsius.

9. The method of claim 7, wherein the microcomputer unit is configured to control the temperature of each of the plurality of electric heaters separately.

10. The method of claim 7, further comprising, inputting the default parameters and indicating the real-time status by a human-machine interface.

11. The method of claim 7, further comprising, adjusting temperatures of a lining layer by a cooling unit.

12. The method of claim 11, wherein the cooling unit comprises a second thermally conductive layer, a concentrator, a convective tube and a plurality of cooling nets, and wherein the second thermally conductive layer is located on the inner side of the thermally insulated layer, and wherein the cooling nets are located between the thermally insulated layer and the second thermally conductive layer.
